(19) United States
(12) Patent Application Publication
(10) Pub. No.: US 2021/0319505 A1
(43) Pub. Date: Oct. 14, 2021

(54) ENTREPRENEUR BANKING PLATFORM

(71) Applicant: Wells Fargo Bank, N.A., San Francisco, CA (US)

(72) Inventors: Shanmukeswara Rao Donkada, Hyderabad (IN); Naga Jyothi Avusingi, Hyderabad (IN)

(21) Appl. No.: 16/558,216

(22) Filed: Sep. 2, 2019

(51) Int. Cl. G06Q 40/02; G06Q 10/06

(52) U.S. Cl. CPC G06Q 40/025; G06Q 10/067

(57) ABSTRACT

A platform provides a portal to connect an entrepreneur prospect and a business entity. A profile of the prospect, including prospect data, can be provided and received. From the profile, an entrepreneur score can be determined for the prospect. The entrepreneur score represents a likelihood of future success of the prospect. A loan can be identified for the prospect to complete a business plan provided by the prospect based on the entrepreneur score. Further, training need can be determined for the prospect based on the profile and business plan, and a loan can be established for the prospect based on the training need of the prospect and the entrepreneur score.

### BACKGROUND

Currently, when prospective borrowers approach a financial institution for a business loan, the financial institution performs risk assessment and based on quick calculations decide whether to provide the loan. As part of the assessment, the financial institution assesses a proposal and the borrower's capability of running the business. However, oftentimes the financial institution does not receive enough information about the borrower. Further, the financial institution and the borrower have not had an established relationship that can be mutually beneficial.

### SUMMARY

The following presents a simplified summary to provide a basic understanding of some aspects of the disclosed subject matter. This summary is not an extensive overview. It is not intended to identify key/critical elements of the innovation or to delineate the scope of the innovation. Its sole purpose is to present some concepts in a simplified form as a prelude to the more detailed description that is presented later.

Briefly described, the subject disclosure pertains to an entrepreneur banking platform that facilitates connecting entrepreneurs to a financial institution as well as other entrepreneurs. A prospective entrepreneur provides information, including an entrepreneurial endeavor, to the platform, for example by way of an application executing on a computing device of the entrepreneur that interacts with the platform. From the information, a profile is generated and stored. Subsequently, the profile can be updated manually by the entrepreneur or automatically by the platform. An entrepreneur score, representative of the likelihood of future success in an endeavor, can be generated from the profile. A financial institution can use the score alone or in combination with the profile to generate an offer, such as for a business or education loan. The platform also enables peer-to-peer communication such that entrepreneurs can post concerns and receive solutions from other entrepreneurs.

To the accomplishment of the foregoing and related ends, certain illustrative aspects of the innovation are described herein in connection with the following description and the annexed drawings. These aspects are indicative of but a few of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an overview of an example implantation of aspects of the disclosure.

FIG. 2 illustrates an example component diagram of an entrepreneur banking platform.

FIG. 3 illustrates an example component diagram of an offer component.

FIG. 4 illustrates a method for entrepreneur banking.

FIG. 5 illustrates a method for entrepreneur banking.

FIG. 6 depicts an exemplary flow diagram associated with transition from prospective customer to small business customer by way of the entrepreneur banking platform.

FIG. 7 shows a profile creation flow diagram.

FIG. 8 illustrates a profile update flow diagram.

FIG. 9 illustrates a method for processing enterprise customer requests.

FIG. 10 depicts an example scoring process.

FIG. 11 illustrates a suitable environment in which various aspects of the disclosed subject matter can be implemented

### DETAILED DESCRIPTION

A business entity, such as a financial institution, values pre-engagement with talented future prospects aspiring to establish their own business plan. A financial institution also values an established trust between the financial institution and a prospect so that the financial institution can approve business loans when the prospect approaches the financial institution in future. A prospect values an established relationship that may provide better loan terms based on the relationship.

A platform is disclosed herein that facilitates connecting a financial institution to prospective entrepreneurs. The platform can produce and dynamically update an entrepreneur profile for an individual including education, business plan, and goals, among other things. A financial institution can employ the profile to compute an entrepreneur score. Lending decisions can made be based on the computed entrepreneur score, for example, where the score represents a likelihood of future success of the prospect. Furthermore, the platform can provide a mechanism for posting and receiving solutions to issues facing an entrepreneur from other users of the platform.

The subject innovation provides substantial benefits in terms of entrepreneur banking. One advantage resides in an established relationship between a borrower and a financial institution. Another advantage resides in more secure knowledge of the borrower and the likelihood of future success.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

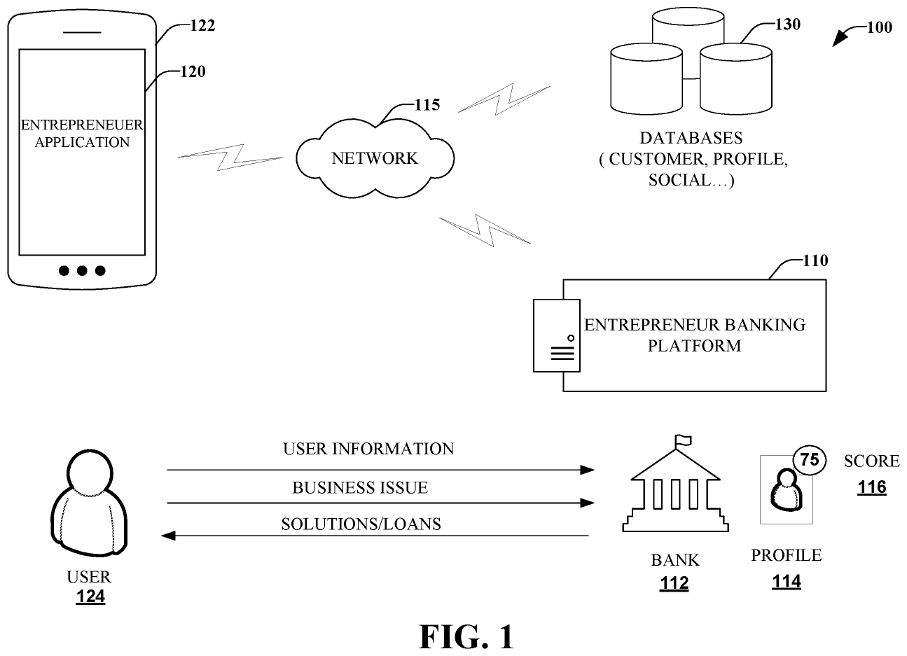

FIG. 1 depicts an overview of an example implementation 100 of aspects of the subject disclosure as described further herein. As shown, entrepreneur banking platform 110 is a computer-based system communicatively coupled to at least one entrepreneur application 120, and databases 130 by way of network 115, which, in one embodiment, can correspond to a wide area network (WAN) such as the Internet. The entrepreneur banking platform 110 can execute on a server device, for example, associated with a bank 112, or other financial institution. The entrepreneur application 120 is installed and executed on computing device 122 of a user 124, or prospect in the context of the bank 112. Entrepreneur application 120 operates in conjunction with the entrepreneur banking platform 110 and databases 130 to enable a user to explore business opportunities, technology challenges, certifications, as well as support for training, higher education, research and development. Moreover, a mechanism is provided to facilitate acquiring business loans to support entrepreneurship by way of the entrepreneur application 120 and entrepreneur banking platform 110. In one instance, interaction can be performed by way of a portal created and exposed by the entrepreneur banking platform 110.

The entrepreneur application 120 includes a user interface to allow the user 124 to provide information for an entrepreneur profile 114. In one example, the profile 114 can include basic user information including education as well as a business plan or goal with timelines. The profile 114 can be stored in one of the databases 130. Subsequently, the profile 114 can be manually updated through the entrepreneur application 120, for example to include progress updates on progress of a business venture. Additionally, the profile 114 can be updated automatically by the entrepreneur banking platform 110, for instance, to update progress based on information acquired from the databases 130. For example, information from a social network site (e.g., LinkedIn, Twitter, Facebook . . . ) of the user 124 can be stored in at least one of the databases 130 and utilized to update data regarding the user 124 or progress with a venture based on analysis of the information.

The entrepreneur banking platform 110 can generate an entrepreneur score 116 associated with the user 124 based on the entrepreneur profile 114. For example, the score 116 can be generated based on evaluation of an entrepreneurship idea and business plan as well as technical skills and academic performance. The score 116 can be utilized as a factor by the bank 112 in determining whether to provide a loan to the user 124 to support an entrepreneurial venture.

The user 124, by way of the entrepreneur application 120, can also post business issues or requests. Other users of the platform 110 can view an issue or request and provide a response, such as a solution, to the issue. For instance, the user 124 can request internship opportunities. In this manner, users can help other users by way of collective or group problem solving. Furthermore, the user 124 can request an education or small business loan. The bank 112 can subsequently grant or deny the request based on the score 116 or the profile 114 of the user 124, among other things. For instance, if the score 116 is greater than a predetermined threshold, the bank 112 can grant a loan to the requesting user 124. Further, the bank 112 can adjust the terms and conditions of the loan based on the score 116 or profile 114.

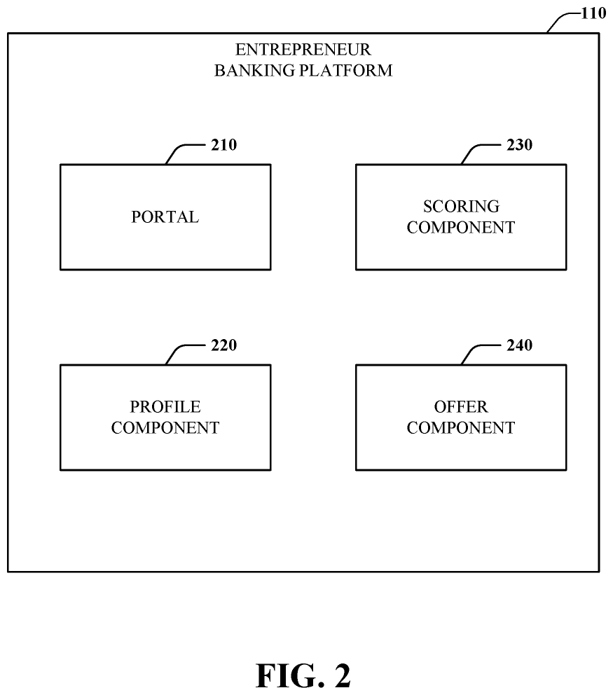

FIG. 2 illustrates a component diagram of an entrepreneur banking platform 110. The system or platform 110 includes a portal 210. The portal 210 connects prospects and a business entity. The portal 210 can be an access point for a prospect (e.g. a user) and a business entity (e.g. a financial institution). In some embodiments, the portal 210 is a web site accessible over servers and/or the internet. In some embodiments, the portal 210 can be accessed by a user device associated with the prospect via a mobile application and/or the like. In other embodiments, the portal 210 resides on a network owned or controlled by the business entity.

The platform 110 also includes a profile component 220. The profile component 220 receives a profile of a prospect. The profile is associated with a prospect or user that has enrolled or otherwise made available information about the prospect to the business entity. The profile includes prospect data of the prospect. The prospect data can include indicating factors at least one of academic performance, technical skills, entrepreneurship skills, experience, employment history, social media data, business plan, goals, and/or the like. In some embodiments, the profile component 220 mines the prospect data from one or more data sources. For example, the profile component 220 can access a prospect's social media or bank account to retrieve data about the prospect to populate the profile of the prospect.

In some embodiments, the prospect registers with the portal 210 via a mobile application. The prospect aids in creation of the profile. The profile is generated based on information provided by the prospect, including but not limited to basic identifying details, education information, business plan/target entrepreneur goal with timelines, and/or the like. In some embodiments, the portal 210 updates the profiles based on progress of prospects captured in data sources such as social media, transcripts, and/or the like. For example, the profile can be updated as a prospect's grade point average fluctuates while in school. In other embodiments, the prospect may provide updates to the profile via the portal 210. For example, if the prospect is interested in an education loan or an internship opportunity, the request for such internship can be made via the portal 210 and the profile component 220 automatically updates the profile of the interested prospect.

In some embodiments, the portal 210 utilizes block chain, distributed ledger principles, and/or the like. On creation of a profile, the portal 210 creates a block in a block chain with prospect data provided in the profile component 220. The profile component 220 connects with social media, university databases training centers, and/or the like to automatically capture the progress of the prospect and update the profile component 220. The profile component 220 updates a profile block in the block chain with relevant updated information.

The platform 110 further comprises a scoring component 230. The scoring component 230 determines an entrepreneur score of the prospect. The scoring component 230 analyzes the profile of the prospect and the indicating factors. The indicating factors are data of the prospect that are indicative of future success. For example, high academic scores or grade point average in science can indicate future success in that field. In some embodiments, the entrepreneur score represents a likelihood of future success of the prospect. In some embodiments, the scoring component 230 determines weights for each indicating factor. The scoring component 230 determines a ranking for each indicator factor of the prospect. In some embodiments, the ranking is determined in relation to other prospects having profiles in the profile component 220. In other embodiments, the ranking can be determined in relation to a requirement of an enterprise customer. The scoring component 230 can determine the entrepreneur score based on the weight and the ranking of each indicating factor.

In some embodiments, the portal 210 can enroll enterprise customers such that the enterprise customers can provide a business problem statement and/or requirements. The enterprise customers can connect to prospects in the portal 210. The business problem statement can be visible to all enrolled prospects. Prospects that are interested can provide solutions to the business problem statement. In some embodiments, the enterprise customers can receive solutions from the prospects. The enterprise customers can evaluate the prospects based on the profile, an entrepreneur score, proposed solutions to business problems, and/or the like or combination thereof. The enterprise customer may provide internship opportunities for requested and suitable prospects. Based on a prospect's interaction or response to the business problem statement, the profile component 220 updates the profile.

The platform 110 includes an offer component 240. The offer component 240 receives the entrepreneur score from the scoring component 230. The offer component 240 determines an offer to the prospect from the business entity based on the entrepreneur score and/or other analysis of the profile of the prospect. An offer can be a service and/or product associated with the business entity. In some embodiments, the offer is a loan or other type of financial instrument. The offer component 240 determines a loan for the prospect to complete a business plan provided by the prospect. The loan can include loan parameters based on the entrepreneur score. In some embodiments, the loan parameters include an interest rate, term, financing amount, and/or the like. The offer component 140 determines the amount and/or interest rate based on the entrepreneur score. For example, a high entrepreneur score can increase the financing amount and/or lower the interest rate.

In some embodiments, the offer component 240 can determine a training need for the prospect based on an analysis or review of the profile. In some embodiments, the training need is one of an internship, a business opportunity, a technology opportunity, a certification, an education degree, research and development support, and/or the like. In other embodiments, the training need is determined by analyzing a business plan of the prospect. For example, a business plan states that the prospect wishes to develop a smartphone application. The offer component 240 can determine that a degree in computer programming should be pursued.

The offer component 240 can develop a loan for the prospect based on the training need. The loan includes loan parameters based on the training need and the entrepreneur score. In the example, the offer component 140 can determine the financing amount for the degree in computer programming and generate a loan offer accordingly. The offer component 240 can generate and send or communicate the offer to the prospect via the portal 210. In some embodiments, the profile is updated with the loan offer and/or the block chain may be updated by the profile component 220.

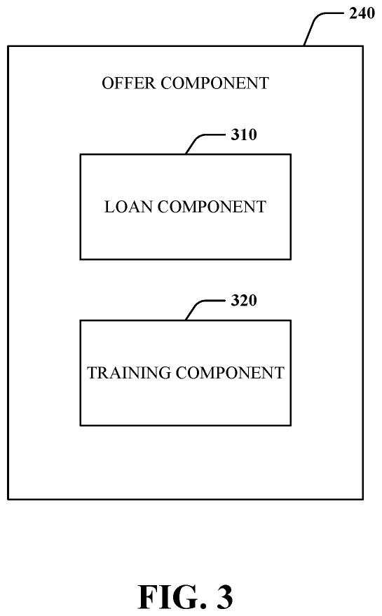

FIG. 3 illustrates a detailed component diagram of the offer component 240. The offer component 240 determines an offer to the prospect from the business entity based on the entrepreneur score and/or other analysis of the profile of the prospect. An offer can be a service and/or product associated with the business entity. In some embodiments, the offer is a loan or other type of financial instrument.

The offer component 240 includes a loan component 310. The loan component 310 determines a loan for the prospect to complete a business plan provided by the prospect. The loan can include loan parameters based on the entrepreneur score. In some embodiments, the loan parameters include an interest rate and financing amount. The amount and interest rate can be determined or affected by the entrepreneur score. For example, a high score can increase the financing amount and/or lower the interest rate.

In some embodiments, the offer component 240 includes a training component 320. The training component 320 can determine a training need for the prospect based on an analysis or review of the profile. In some embodiments, the training need is one of an internship, a business opportunity, a technology opportunity, a certification, an education degree, research and development support, and/or the like. In other embodiments, the training need is determined by analyzing a business plan of the prospect. For example, a business plan states that the prospect wishes to develop a smartphone application. The training component 320 can determine that a degree in computer programming should be pursued.

The loan component 310 can develop a loan for the prospect based on the training need. The loan includes loan parameters based on the training need and the entrepreneur score. In some embodiments, a generated loan offer can be updated based on a newly determined training need. In the example, the loan component 310 can determine the financing amount for the degree in computer programming and generate a loan offer accordingly. The offer component 240 can generate and send or communicate the offer to the prospect.

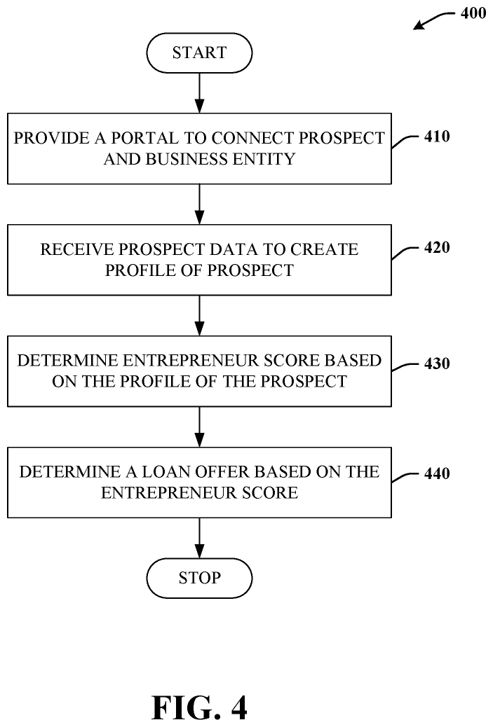

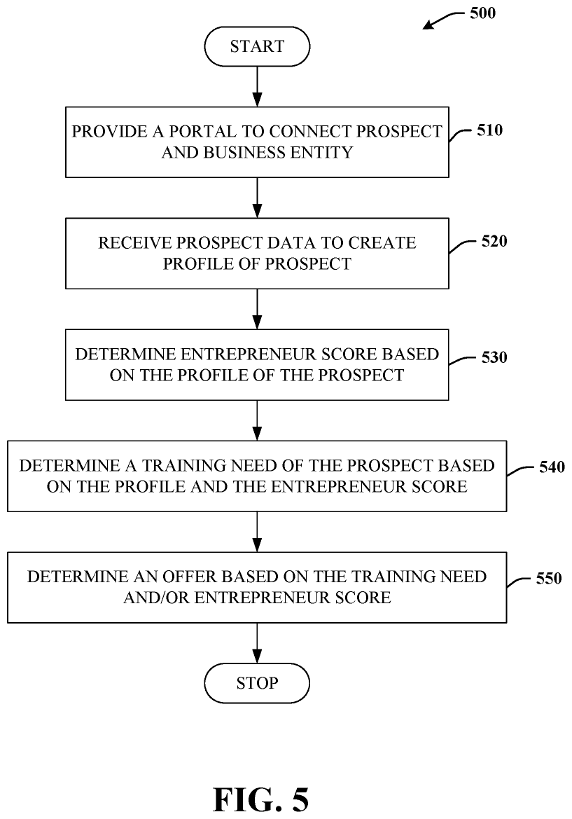

In view of the platform described above, methods that may be implemented in accordance with the disclosed subject matter will be better appreciated with reference to flow chart diagrams of FIGS. 4 and 5. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Each block or combination of blocks can be implemented by computer program instructions that can be provided to a processor to produce a special-purpose machine, such that the instructions executing on the processor create a means for implementing functions specified by a flow chart block.

FIG. 4 illustrates a method 400 for the entrepreneur banking platform 110. At 410, a portal 210 is provided to connect prospects and business entities. The portal 210 can be a website, mobile application, and/or the like. At 420, prospect data of a prospect is received at the portal to create a profile 114 of the prospect, for example by the profile component 220. The prospect data can be provided by the prospect during an enrollment. In some embodiments, a data miner can retrieve prospect data about the prospect from data sources accessed over a network. For example, a prospect enrolls for entrepreneur banking with the portal. The prospect can provide some or all of prospect data to the portal 210 via an interface of the portal. Missing data or extra data can be obtained using social media, university sources, and/or the like to create a more complete profile in the portal.

At 430, an entrepreneur score 116 of the prospect is determined, for instance by the scoring component 230. The entrepreneur score 116 can be determined by ranking indicating factors in the prospect's profile 114. The entrepreneur score 116 can be an aggregate of the rankings. In some embodiments, the entrepreneur score 116 can be an average, weighted average, and/or the like of the ranked indicating factors in the prospect's profile 114. The entrepreneur score 116 can indicate a likelihood of success for the prospect in the future. In the example, the prospect's profile 114 includes an average grade point average, high standardized-test scores, and a business plan to create a mobile application. The entrepreneur score can be determined by ranking the grade point average and the standardized test scores and applying a weight to each. For example, the entrepreneur score 116 can more heavily weight the test scores and business plan over grade point average. The entrepreneur score 116 can be an aggregate of the grade point average and the standardized test score to determine a high entrepreneur score of the prospect.

At 440, a loan offer is determined based on the entrepreneur score 116, for example by the offer component 240. The loan offer includes loan parameters. The loan parameters can include financing amount, interest rate, term, and/or the like. The entrepreneur score 116 can affect the loan parameters and/or loan offer. The loan offer can be communicated to the prospect by way of the portal 210 or another communication mode. Continuing the example, the prospect has a high entrepreneur score 116. The loan parameters are adjusted to be more favorable to the prospect for a small business loan to help the prospect start or pursue the business plan of developing their mobile application.

FIG. 5 illustrates a method 500 for the entrepreneur banking platform 110. At 510, a portal 210 is provided to connect prospects and business entities. The portal 210 can be a website, mobile application, and/or the like. At 520, prospect data of a prospect is received at the portal to create a profile of the prospect. The prospect data can be provided by the prospect during an enrollment. In some embodiments, a data miner can retrieve prospect data about the prospect from data sources accessed over a network. For example, a prospect enrolls for entrepreneur banking with the portal. The prospect can provide some or all of prospect data to the portal 210 via an interface of the portal 210. Missing data or extra data can be obtained using social media, university sources, and/or the like to create a more complete profile in the portal.

At 530, an entrepreneur score 116 of the prospect is determined, for instance by the scoring component 230. The entrepreneur score 116 can be determined by ranking indicating factors in the prospect's profile. The entrepreneur score 116 can be an aggregate of the rankings. In some embodiments, the entrepreneur score can be an average, weighted average, and/or the like of the ranked indicating factors in the prospect's profile. In the example, the prospect's profile 114 includes an average grade point average, high standardized-test scores, and a business plan to create a mobile application. The entrepreneur score 116 can be determined by ranking the grade point average and the standardized test scores and applying a weight to each. For example, the entrepreneur score 116 can more heavily weight the test scores and business plan over grade point average. The entrepreneur score 116 can be an aggregate of the grade point average and the standardized test score to determine a high entrepreneur score 116 of the prospect.

At 540, a training need or recommendation is determined for the prospect, for example as determined by the training component 320. The training need is based on the profile 114 of the prospect, the entrepreneur score 116, and/or the like. In some embodiments, the training need is one of an internship, a business opportunity, a technology opportunity, a certification, an education degree, research and development support, and/or the like. In other embodiments, the training need is determined by analyzing a business plan of the prospect. Continuing the example, the prospect has only an average grade point average but high-standardized test scores. The training need can be determined for the prospect that the prospect needs graduate school before pursuing their business plan. Further, the business plan states that the prospect wishes to develop a mobile application. The training need for the prospect can be determined as a master's degree in computer programming.

At 550, a loan offer is determined, for example by the loan component 310, based on the entrepreneur score and the training need. The loan offer includes loan parameters. The loan parameters can include financing amount, interest rate, term, and/or the like. The entrepreneur score and the training need can affect the loan parameters and/or loan offer. The loan offer can be communicated to the prospect via the portal or another communication mode. Continuing the example, the prospect has a high entrepreneur score and a training need for a master's degree in computer programming. The loan parameters are adjusted for the prospect for an education loan to help the prospect start or pursue the master's degree before developing their mobile application. The financing amount can be equal to the cost of tuition for the master's degree, estimated living expenses and/or the like.

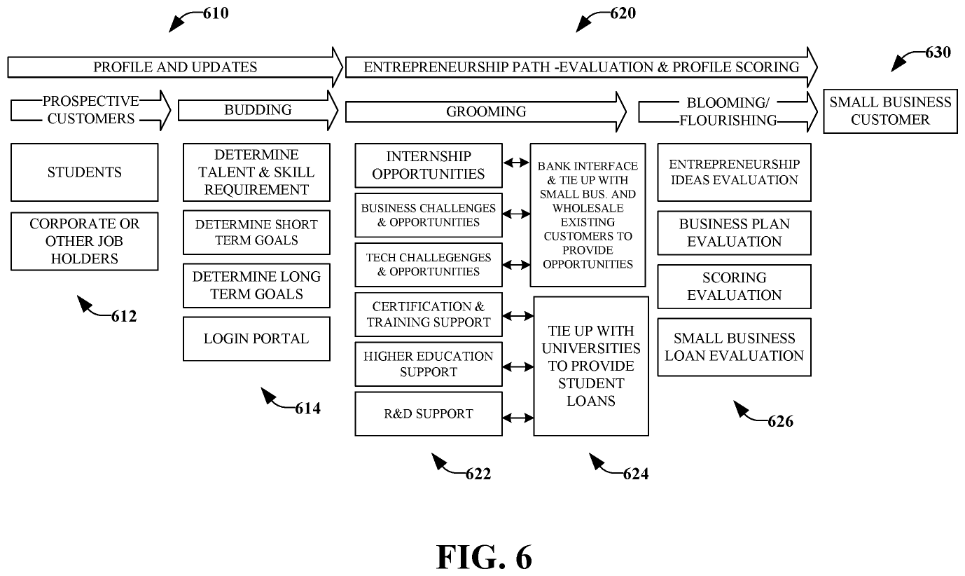

FIG. 6 depicts an exemplary flow diagram associated with the entrepreneur banking platform 110. At 610, a profile can be created and updated. Prospective customers 612 including students and corporate or other job holders can register with the entrepreneur banking platform 110 and download an application to his or her mobile device. Using the application, the prospective customers can create and later update a profile. As part of creating a profile and to facilitate budding, a talent and skillset requirements, short-term goals, and long-term goals can be determined as illustrated at 614.

In the next stage, at 620, entrepreneurship path provided including evaluation and profile scoring. To prepare s prospective customers for success, various opportunities can be provided, at 622, including internship, business challenges, and technological challenge. Further, support can be provided with respect to certification and training, higher education and research and development (R&D). At 624, opportunities can be provided by connecting prospective customers with existing customers. As per support, connections can be made with universities to provide student loans. To facilitate blooming or flourishing, at 626, various services can be provided including entrepreneurship idea evaluation, business plan evaluation, scoring evaluation, and small business loan evaluation. Finally, in the end the prospective customer can be converted to an existing small business customer at 630.

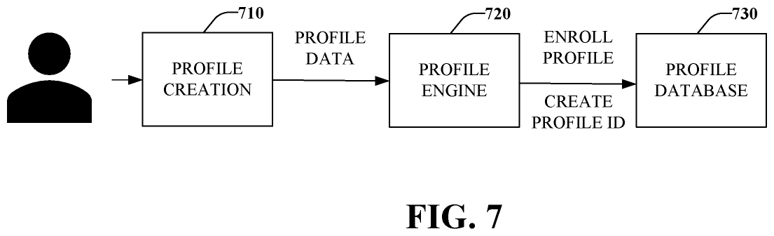

Turning to FIG. 7, an enrollment process is illustrated. At 710, a prospective customer can utilize and interface to creation a profile. Profile information input can include basis details, education, and business plan/target entrepreneurship goal with timelines. The result is profile data which is transferred to the profile engine 720. The profile engine 770 is part of the entrepreneur banking platform 100 and can correspond to the previously described profile component 220. The profile engine 720 subsequently creates a profile and saves the profile to profile database 730.

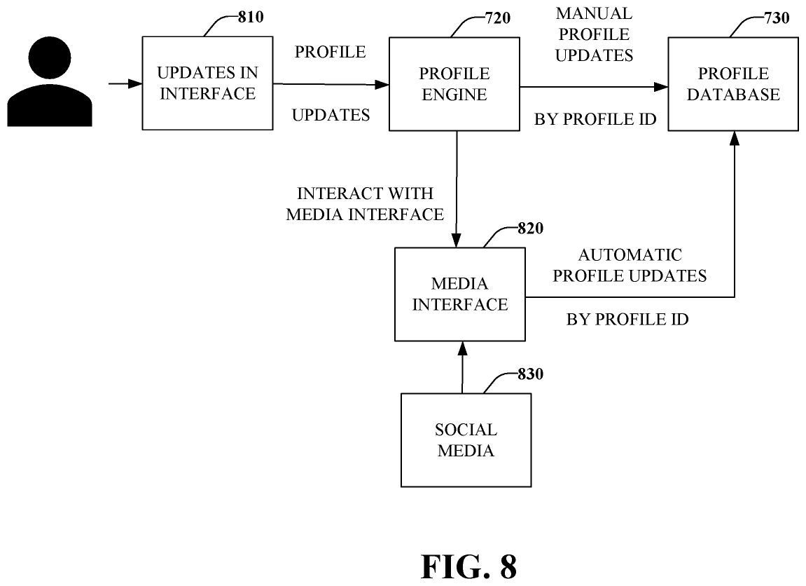

FIG. 8 depicts a profile update process. At 810, a user updates his or her profile utilizing an interface, for example as part of a mobile application. The profile updates are then provided to the profile engine 720. The profile engine 720 subsequently updates the profile database 730 with manual profile updates by profile identifier. Further, the profile engine 720 can interact with media interface 820 to acquire updates by profile information at 820. The media interface 820 can continuously receive feeds or input about user progress from social media 830 and enable automatic profile updates by profile identifier to the profile database 730 based on progress captured. For example, the media interface 820 can connect to university databases and other training centers and automatically capture the progress of a user and update the profile database 730.

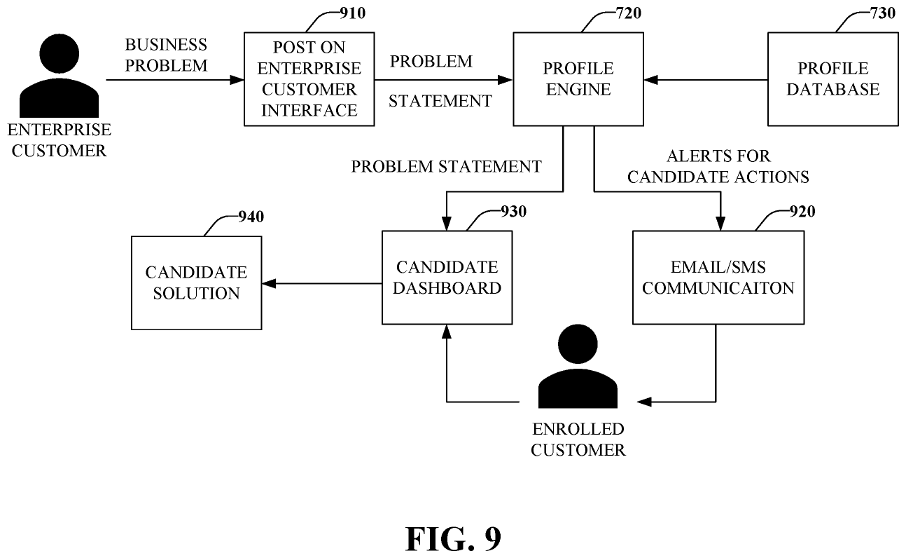

FIG. 9 illustrates a method for processing enterprise customer requests. At 910, an enterprise customer, such as a business entity, can specify a business problem or their requirements in an interface. A problem statement is provided to the profile engine 720. The profile engine identifies enrolled customers and sends alerts such as email or short message service communication to the enrolled customers. The enrolled customers are thus notified of a post of a business problem or the like. An enrolled customer can then interact with the post by way of candidate dashboard 930 and provide a candidate solution 940 to the business problem.

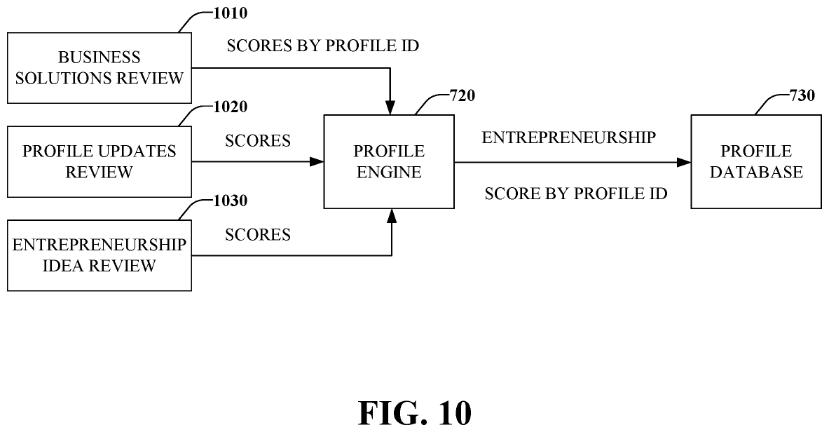

FIG. 10 illustrates an entrepreneur banking platform 100 process of reviewing and tracking candidate progress to calculate an entrepreneur score for each candidate. In one embodiment, scoring engines can determine entrepreneur score based on profile information of the candidate including academic performance, technical skills, entrepreneurship ideas in response to enterprise customer problems, and business plan. Using the entrepreneur score, a decision can be made regarding how to allocate business loans for candidates with high scores. As shown, three scorers or scoring components are provided associated with enabling manual or automatic scoring based on business solutions review 1010, profile updates review 1020, and entrepreneurship idea review 130. Scores are provided, by profile identifier, to the profile engine 720. The profile engine 720 then computes an entrepreneurship score based on the received scores and saves the entrepreneurship score by profile indenter to the profile database 730

Portions of the subject disclosure focus on entrepreneurs and a financial institution, wherein the financial institution provides loans. However, the subject disclosure is not limited to this particular embodiment. For instance, entrepreneurs can interact with any business entity, which provides different products and services. Further, entrepreneurs can merely be prospective customers or clients of the business entity.

The subject disclosure pertains to various products and processes that perform, or are configured to perform, various actions regarding a platform that connects entrepreneurs to business entities (e.g., financial institution) and other entrepreneurs. What follows are one or more example systems and methods.

A method begins by providing a portal to connect prospects and a business entity. The method includes receiving, by the portal, a profile of a prospect, the profile including prospect data of the prospect. The method includes determining an entrepreneur score of the prospect based on the profile of the prospect, wherein the entrepreneur score represents a likelihood of future success of the prospect. The method includes determining an offer to the prospect from the business entity based on the entrepreneur score.

A system can include a portal that connects prospects and a business entity. A profile component receives a profile of a prospect, the profile including prospect data of the prospect. A scoring component determines an entrepreneur score of the prospect based on the profile of the prospect, wherein the entrepreneur score represents a likelihood of future success of the prospect. An offer component determines an offer to the prospect from the business entity based on the entrepreneur score.

A computer-readable storage medium includes instructions to control one or more processors. The instructions include providing a portal to connect prospects and a business entity. The instructions include receiving, by the portal, a profile of a prospect, the profile including prospect data of the prospect. The instructions include determining an entrepreneur score of the prospect based on the profile of the prospect, wherein the entrepreneur score represents a likelihood of future success of the prospect. The instructions include determining a loan for the prospect to complete a business plan provided by the prospect based on the entrepreneur score, wherein the loan includes loan parameters based on the entrepreneur score. The instructions include determining a training need for the prospect based on an analysis of the profile. The instructions include updating the loan for training based on the determined training need, wherein the loan includes loan parameters based on the training need and the entrepreneur score.

As used herein, the terms “component,” “system,” and “platform,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

Furthermore, the disclosed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

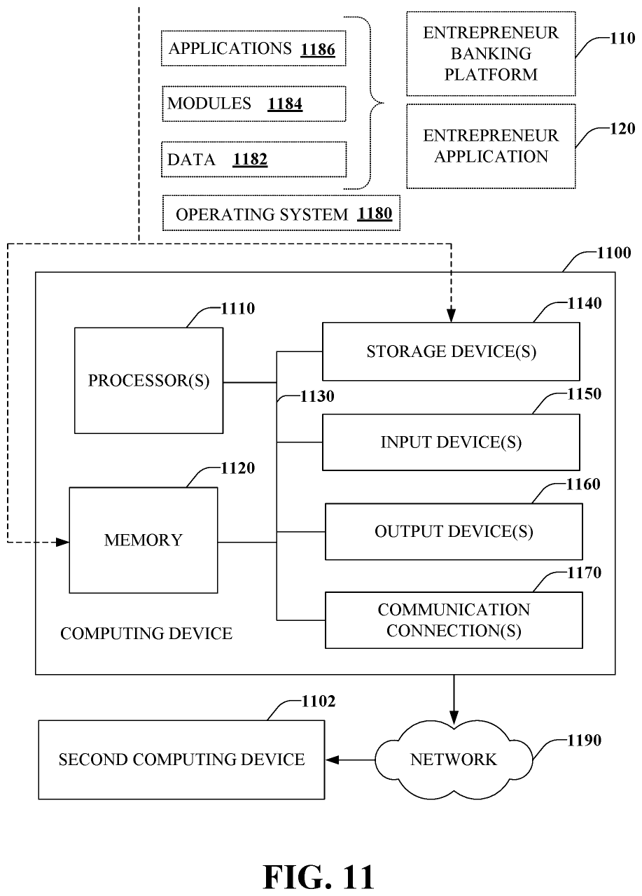

To provide a context for the disclosed subject matter, FIG. 11 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 11, illustrated is an example computing device 1100 (e.g., desktop, laptop, tablet, watch, server, hand-held, programmable consumer or industrial electronics, set-top box, game system, compute node . . . ). The computing device 1100 includes one or more processor(s) 1110, memory 1120, system bus 1130, storage device(s) 1140, input device(s) 1150, output device(s) 1160, and communications connection(s) 1170. The system bus 1130 communicatively couples at least the above system constituents. However, the computing device 1100, in its simplest form, can include one or more processors 1110 coupled to memory 1120, wherein the one or more processors 1110 execute various computer executable actions, instructions, and or components stored in the memory 1120.

The processor(s) 1110 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1120 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 1120 can be a graphics processor unit (GPU) that performs calculations with respect to digital image processing and computer graphics.

The computing device 1100 can include or otherwise interact with a variety of computer-readable media to facilitate control of the computing device to implement one or more aspects of the disclosed subject matter. The computer-readable media can be any available media that accessible to the computing device 1100 and includes volatile and nonvolatile media, and removable and non-removable media. Computer-readable media can comprise two distinct and mutually exclusive types, namely storage media and communication media.

Storage media includes volatile and nonvolatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 1100. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 1120 and storage device(s) 1140 are examples of computer-readable storage media. Depending on the configuration and type of computing device, the memory 1120 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 1100, such as during start-up, can be stored in nonvolatile memory, while volatile memory can act as external cache memory to facilitate processing by the processor(s) 1120, among other things.

The storage device(s) 1140 include removable/non-removable, volatile/non-volatile storage media for storage of vast amounts of data relative to the memory 1120. For example, storage device(s) 1140 include, but are not limited to, one or more devices such as a magnetic or optical disk drive, floppy disk drive, flash memory, solid-state drive, or memory stick.

Memory 820 and storage device(s) 1140 can include, or have stored therein, operating system 1180, one or more applications 1186, one or more program modules 1184, and data 982. The operating system 1180 acts to control and allocate resources of the computing device 1100. Applications 1186 include one or both of system and application software and can exploit management of resources by the operating system 1180 through program modules 1184 and data 1182 stored in the memory 1120 and/or storage device(s) 1140 to perform one or more actions. Accordingly, applications 1162 can turn a general-purpose computer 1102 into a specialized machine in accordance with the logic provided thereby.

All or portions of the disclosed subject matter can be implemented using standard programming and/or engineering techniques to produce software, firmware, hardware, or any combination thereof to control the computer device 1100 to realize the disclosed functionality. By way of example and not limitation, all or portions of the entrepreneur banking platform 110 or entrepreneur application 120 can be, or form part of, the application 1186, and include one or more modules 1184 and data 1182 stored in memory and/or storage device(s) 1140 whose functionality can be realized when executed by one or more processor(s) 1110.

In accordance with one particular embodiment, the processor(s) 1120 can correspond to a system on a chip (SOC) or like architecture including, or in other words integrating, both hardware and software on a single integrated circuit substrate. Here, the processor(s) can include one or more processors as well as memory at least similar to the processor(s) 1110 and memory 1120, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the entrepreneur banking platform 110 or entrepreneur application 120 and/or functionality associated therewith can be embedded within hardware in a SOC architecture.

The input device(s) 1150 and output device(s) 1160 can be communicatively coupled to the computing device 1100. By way of example, the input device(s) 1150 can include a pointing device (e.g., mouse, trackball, stylus, pen, touch pad . . . ), keyboard, joystick, microphone, camera, motion sensor, and a global positioning satellite (GPS) receiver and transmitter, among other things. The output device(s) 1160, by way of example, can correspond to a display device (e.g., liquid crystal display (LCDP), light emitting diode (LED), plasma, organic light-emitting diode display (OLED) . . . ), speakers, printer, and vibration motor, among other things. The input device(s) 1150 and output device(s) 1160 can be connected to the computing device 1100 by way of wired connection (e.g., bus), wireless connection (e.g., Wi-Fi, Bluetooth . . . ), or a combination thereof.

The computing device 1100 can also include communication connection(s) 1170 to enable communication with at least a second computing device 1102 by means of a network 1190. The communication connection(s) 1170 can include wired or wireless communication mechanisms to support network communication. The network 1190 can correspond to a local area network (LAN) or a wide area network (WAN) such as the Internet. The second computing device 1102 can be another processor-based device with which the computing device 1102 can interact.

In accordance with one embodiment, the entrepreneur banking platform 110 can be executed on the computer device 1100 and the entrepreneur application 120 can execute on the second computing device 1102. Instructions specifying functionality associated with the entrepreneur banking platform 110 and the entrepreneur application 120 can be executed on respective computing devices by loading the instructions in memory for subsequent execution by the processor(s) 1110. Further, communication is enabled over the network 1190 by way of the communication connection(s) 1170. On the second computing device 1102, the input device(s) can be utilized to acquire information about an entrepreneur and business venture, for example. For instance, a keyboard and pointing device can be utilized to capture the information. The information can be received by the entrepreneur banking platform over the network 1190 and subsequently a profile 114 is generated and a score 116 produced from the profile by the processor(s) 1110. The profile 114 and the score 116 are further stored in one or more of the storage device(s) 1140 for subsequent retrieval and processing. In one instance, the entrepreneur banking platform 110 by way of the computing device 1100 can cannot to the network 1190 and acquire further information about an entrepreneur and associated business venture including progress, among other things, to further refine the profile 114 and score 116. If an entrepreneurial user of the entrepreneur application 120 requests a loan for a small business or education associated therewith, the entrepreneur banking platform 110 utilizing the processor(s) 1110 can determine whether or not to approve such a loan based at least on the score 116 and communicate a decision back to the entrepreneur application 120 on the second computing device 1102.

Additionally, the entrepreneur banking platform 110 can host a network of entrepreneurial users and enable communication and collaboration amongst users. In this this context, the entrepreneur application 120 on the second computing device 1102 can communicate with the entrepreneur banking platform 110 to send and receive data to and from other users. More specifically, the processor(s) can enable presentation of such information on a display and engage input device(s) 1150 to receive input such as requests and responses from users. The processor(s) 1110 on the computing device 1100 can coordinate messages to create a social network of entrepreneurs.

What has been described above includes examples of aspects of the subject innovation. It is, of course, not possible to describe every conceivable combination of components or methods, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
providing a portal to connect prospects and a business entity, wherein the portal is provided by a System On a Chip (SOC);
receiving, by the portal, an initial profile of a prospect, the profile including prospect data of the prospect;
determining an entrepreneur score of the prospect based on the profile of the prospect, wherein the entrepreneur score represents a likelihood of future success of the prospect;
updating a set of entrepreneur factors that are augmented by mining social media related to the prospect and the business entity, wherein the set of entrepreneur factors includes academic performance, technical skills, entrepreneur skills, and ongoing experience of the prospect and wherein determining is completed on the SOC that integrates the initial profile and the updated set of entrepreneur factors; and
configuring an offer for the prospect from a set of existing items, wherein the configuring changes the terms of the set of existing items based on the entrepreneur score so that the configured changes enable a progress path that facilitates blooming between the prospect and the business entity.

2. The method of claim 1, further comprising determining an offer to the prospect from the business entity based on the entrepreneur score, wherein the offer comprises one or more of determining a specifically configured loan, a training need, or an evaluation service.

3. The method of claim 2, wherein
determining the specifically configured loan provides a loan for the prospect to complete a business plan provided by the prospect, wherein the loan includes loan parameters based on the entrepreneur score, and the business plan addresses a problem of the business entity.

4. The method of claim 2, wherein
determining the training need for the prospect is based on an analysis of the profile and the SOC connects to potential sources of training that captures progress to augment the entrepreneur score.

5. The method of claim 4, comprising:
determining a loan for training based on the determined training need, wherein the loan for training includes loan parameters based on the training need and the entrepreneur score, and that have terms that are adjusted based on the captured progress.

6. The method of claim 4, comprising:
wherein the training need is at least one of an internship, a business opportunity, a technology opportunity, a certification, an education degree, research or development support.

7. The method of claim 1, further
wherein the set of entrepreneur factors include success factors related to each of the prospect and the business entity.

8. The method of claim 7, determining the score comprising:
determining weights for each indicating factor;
determining a ranking for each indicator factor of the prospect; and
determining the entrepreneur score based on the weight and the ranking.

9. The method of claim 1, wherein the
mining by the SOC provides data not supplied by the initial profile.

10. A system, comprising:
a portal that connect prospects and a business entity, wherein the portal is provided by a System On a Chip (SOC);
a profile component that receives an initial profile of a prospect, the profile including prospect data of the prospect;
a scoring component that determines an entrepreneur score of the prospect based on the profile of the prospect, wherein the entrepreneur score represents a likelihood of future success of the prospect;
wherein the SOC updates a set of entrepreneur factors that are augmented by mining social media related to the prospect and the business entity, wherein the set of entrepreneur factors includes academic performance, technical skills, entrepreneur skills, and ongoing experience of the prospect and wherein determining is completed on the SOC that integrates the initial profile and the updated set of entrepreneur factors; and
an offer component that configures an offer for the prospect from a set of existing items, wherein the configuring changes the terms of the set of existing items based on the entrepreneur score so that the configured changes enable a progress path that facilitates blooming between the prospect and the business entity.

11. The system of claim 10, wherein
the offer to the prospect from the business entity is based on the entrepreneur score, wherein the offer comprises one or more of determining a specifically configured loan, a training need, or an evaluation service.

12. The system of claim 11, the offer component comprising:
a loan component that determines the specifically configured loan for the prospect to complete a business plan provided by the prospect, wherein the loan includes loan parameters based on the entrepreneur score, and the business plan addresses a problem of the business entity.

13. The system of claim 11, the offer component comprising:
a training component that determines the training need for the prospect based on an analysis of the profile and the SOC connects to potential sources of training that captures progress to augment the entrepreneur score.

14. The system of claim 13, wherein
the loan component determines a loan for training based on the determined training need, wherein the loan for training includes loan parameters based on the training need and the entrepreneur score, and that have terms that are adjusted based on the captured progress.

15. The system of claim 13, comprising:
wherein the training need is at least one of an internship, a business opportunity, a technology opportunity, a certification, an education degree, research or development support.

16. The system of claim 10, further
wherein the set of entrepreneur factors include success factors related to each of the prospect and the business entity.

17. The system of claim 16, comprising:
wherein the scoring component:
determines weights for each indicating factor;
determines a ranking for each indicator factor of the prospect; and
determines the entrepreneur score based on the weight and the ranking.

18. The system of claim 10, wherein the profile component mines data not supplied by the initial profile.

19. A computer-readable storage medium having instructions, that when executed by one or more processors, control the one or more processors to:
provide a portal to connect prospects and a business entity;
receive, by the portal, an initial profile of a prospect, the profile including prospect data of the prospect;
determine an entrepreneur score of the prospect based on the profile of the prospect, wherein the entrepreneur score represents a likelihood of future success of the prospect;
update a set of entrepreneur factors that are augmented by mining social media related to the prospect and the business entity, wherein the set of entrepreneur factors includes academic performance, technical skills, entrepreneur skills, and ongoing experience of the prospect and wherein determining is completed on the SOC that integrates the initial profile and the updated set of entrepreneur factors; and
configure an offer for the prospect from a set of existing items, that changes the terms of the set of existing items based on the entrepreneur score so that the configured changes enable a progress path that facilitates blooming between the prospect and the business entity, wherein the offer comprises one or more of determining a specifically configured loan, a training need, or an evaluation service,
wherein the determining the specifically configured loan for the prospect to complete a business plan provided by the prospect is based on the entrepreneur score, wherein the loan includes loan parameters based on the entrepreneur score, and the business plan addresses a problem of the business entity.

20. The computer-readable storage medium of claim 19, wherein the instructions further control the one or more processors to:
determine a training need for the prospect based on an analysis of the profile and connects to potential sources of training that captures progress to augment the entrepreneur score; and
update the loan for training based on the determined training need, wherein the loan includes loan parameters based on the training need and the entrepreneur score, and that have terms that are adjusted based on the captured progress.
